(19) United States
(12) Patent Application Publication
(10) Pub. No.: US 2004/0053534 A1
(43) Pub. Date: Mar. 18, 2004

(54) Plug-in connector module

(75) Inventors: Andre Beneke, Vechta (DE); Heiko Meier, Rahden (DE); Uwe Sundermeier, Espelkamp (DE)

Correspondence Address: Norman P. Soloway, HAYES, SOLOWAY P.C., 130 W. Cushing Street, Tucson, AZ, 85701, US

(73) Assignee: HARTING Electric GmbH & Co. KG

(21) Appl. No.: 10/653,558

(22) Filed: Sep. 2, 2003

(30) Foreign Application Priority Data
Sep. 12, 2002 (DE) 202 14 132.2

(51) Int. Cl. H01R 9/03

(52) U.S. Cl. 439/610

(57) ABSTRACT

For the purpose of transmitting signals without interfering radiation, a plug-in connector module is proposed which comprises an electrically conductive shell-type casing, with a connector insert, in a retaining body composed of insulating material.

The plug-in connector module is held by locking means in a module mounting device which, in turn, is integrated into a plug-in connector casing. Within the shell-type casing, an electrically conductive contact with the shielding of a signal-carrying cable is provided, so that it is possible to dispose in the module mounting device, without mutual interference, both a plurality of plug-in connector modules having mutually independent earth potentials and plug-in connector modules which transmit a power supply, pneumatic supply or suchlike.

The invention relates to a plug-in connector module with a shielding against interfering radiation, for use in a module mounting device of a plug-in connector casing.

Such a plug-in connector module is required in order that electrical signals which are susceptible to interference can be transmitted by means of an industrial connector casing in which modules having different power potentials are disposed.

Known from DE 36 15 356 A1 is a cable connector, for connecting a cable to a computer, consisting of two shell halves which are connected to one another so as to be immune to electrical interference and are coated with thermoplastic material so as to be electrically insulated.

Cable connectors of this type are perfectly adequate for the domain of office communication, but are not sufficiently stable and not sufficiently protected against environmental influences for use in the industrial domain.

The invention is therefore based on the object of developing a plug-in connector module of the initially stated type, in an industry-standard connector casing with a module mounting device provided therein, such that shielding against interfering radiation is provided for electrical signals which are susceptible to interference and which are routed by means of shielded cables.

This object is achieved in that an electrically conductive shell-type casing, with a connector insert, is retained in a retaining body composed of insulating material,

the retaining body, with the shell-type casing and the connector insert, can be locked in place in the module mounting device, and there is provided on the shell-type casing a clip by means of which a signal line, leading to the connector insert, can be fastened, the shielding braid of the signal line being contacted to the shell-type casing.

Advantageous embodiments of the invention are disclosed by the claims 2-4.

In automation technology, which is increasingly directed towards a decentralized connection technology, there is also an increasing trend to transmit electrically sensitive signals, e.g., from sensors. Such devices, however, must be of a plug-in design in order to assure a rapid, trouble-free replacement of a defective component.

The plug-in connections, however, must be adapted to the industrial domain and robustly equipped.

The advantages achieved by the invention consist particularly in that such a plug-in connector module, provided for so-called D-sub connector inserts, can be inserted in an already known, proven and robust module mounting device in a respective plug-in connector casing. At the same time, due to the type of construction of this plug-in connector module, it is possible to combine without difficulty, and without mutual interference, both a plurality of shielded plug-in connector modules, having mutually independent earth potentials, and plug-in connector modules which transmit a power supply, pneumatic supply or suchlike. The plug-in connector module consists of a retaining body in which is locked an electrically conductive shell-type casing with a D-sub connector insert.

The shielding braid of a shielded cable is connected to the shell-type casing by means of a screw-clip.

A plurality of plug-in connector modules can thus be used independently of one another within a module mounting device, even with different earth potentials on the shieldings.

An exemplary embodiment of the invention, explained more fully in the following, is represented in the drawing, wherein:

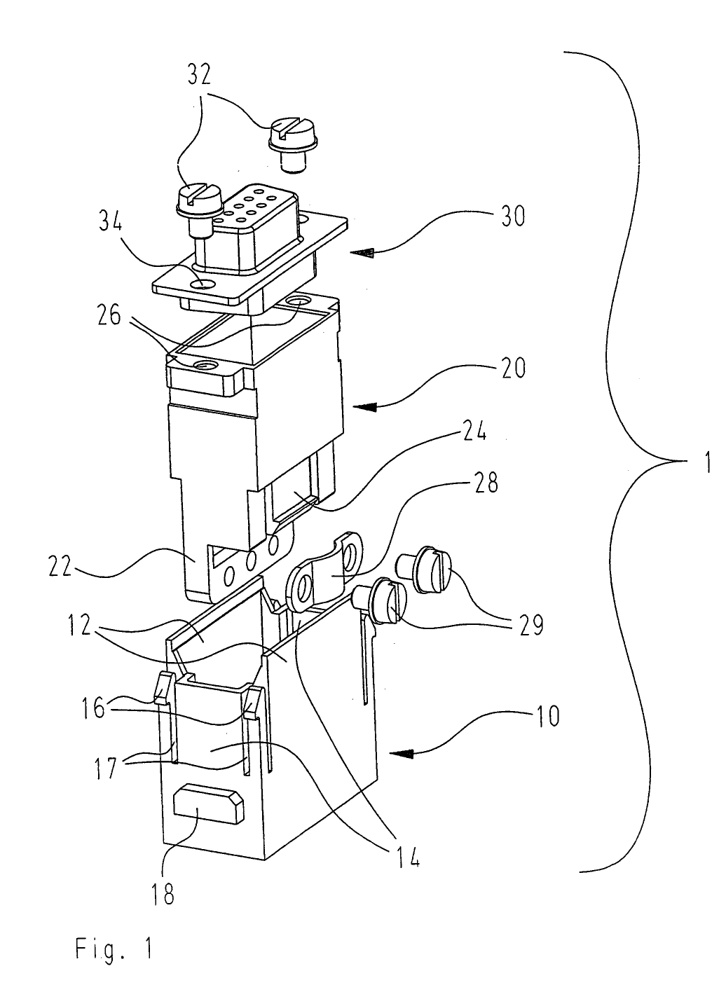

FIG. 1 shows an exploded perspective representation of a plug-in connector module,

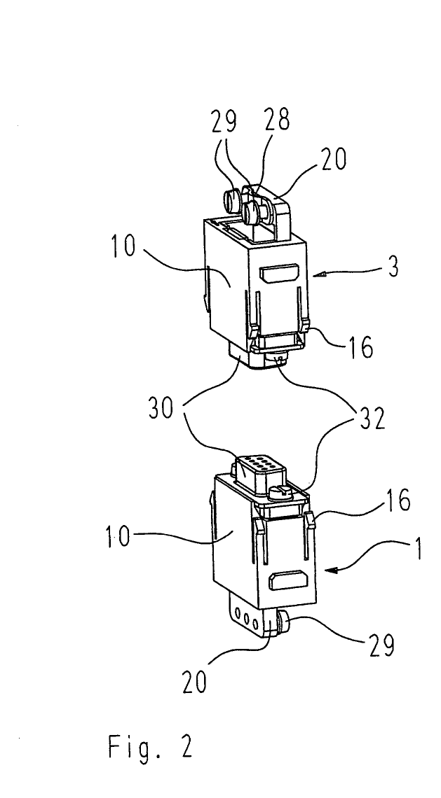

FIG. 2 shows a perspective representation of a plug-in connector module with a mating connector,

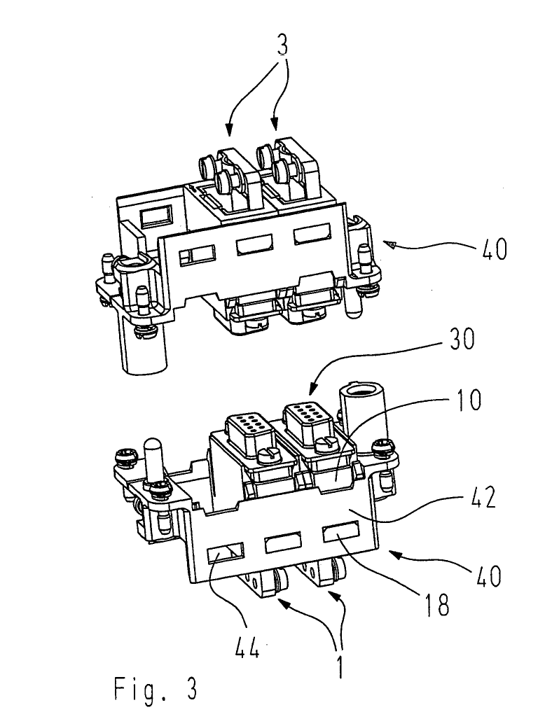

FIG. 3 shows a perspective representation of plug-in connector modules inserted in a module mount, and

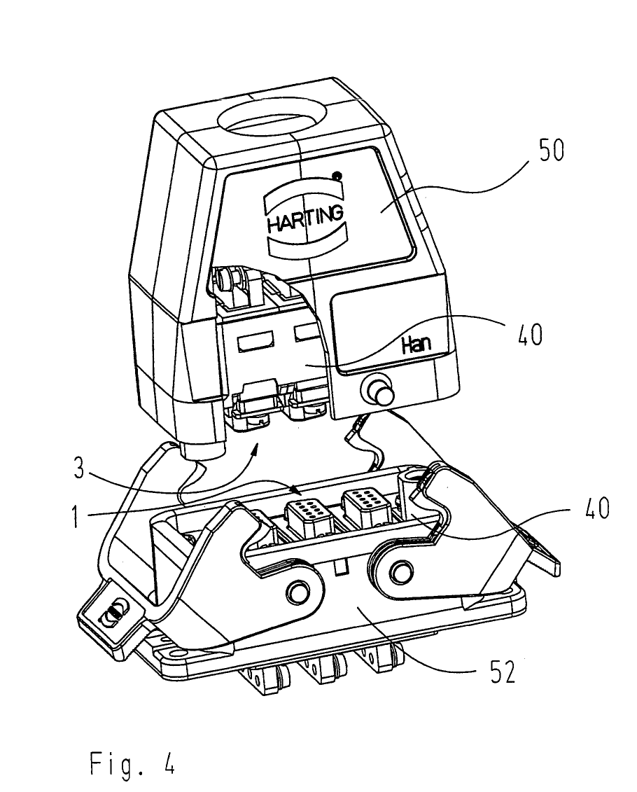

FIG. 4 shows a perspective representation of a module mount with inserted plug-in connector modules in a plug-in connector casing.

FIG. 1 shows, in an exploded representation, the individual elements provided for this plug-in connector module.

The module body 10, which is of a rectangular form, is made from a non-conductive material, two opposing side walls 12 being elongated relative to the two side walls 14 disposed perpendicularly to them.

Fashioned in the corner regions are locking hooks 16, each directed outwards, which are relieved from the side walls by means of a rectangular slot 17. Formed on, below and centrally between the locking hooks, are outwardly directed formed-on elements 18 which can be inserted in corresponding openings 44 in a module mounting device 40.

A shell-type casing 20 can be inserted and locked into the module body 10.

The rectangular shell-type casing comprises a mounting surface 22, elongated relative to the other three side surfaces, for the screw-mounting of a fastening clip 28 by means of which the shielding of a signal cable is contacted to the electrically conductive shell-type casing.

In addition, there are provided on the mating side threaded holes 26 to which the connector insert 30, which in this case has the form of a D-sub connector, can be fastened by means of screws 32. Likewise, a fastening with locking means or rivets can be provided.

FIG. 2 shows a plug-in module 1 and a matching mating connector module 3, each in the assembled but non-mated state, the mating faces being directed towards one another. Significant on the shell-type casing 20, which is locked in the retaining body 10, are both the screwed connections 29 with the fastening clip 28 for an electrically shielded cable, and the connector inserts 30 with the fastening screws 32.

FIG. 3 shows a plurality of plug-in connector modules disposed in an already known module mounting device 40.

The individual modules are positioned in the openings 44 in the mounting frame 40 by means of the formed-on elements 18, while the locking hooks 16 lock on the edge of the side surface 42 of the module mounting device 40.

FIG. 4 shows a complete plug-in connection with a connector casing 50 and a mating connector casing 52, both connectors being provided with a module mounting device 40 in which the connector modules, in turn, are mounted.

In this figure, the casing 50 has been partially cut away in order to show the module mounting device 40 with the connector modules 1, 3 inserted therein.

1. Plug-in connector module (1) with a shielding against interfering radiation, for use in a module mounting device (40) of a plug-in connector casing (50), characterized in
that an electrically conductive shell-type casing (20), with a connector insert (30), is retained in a retaining body (10) composed of insulating material, and in
that the retaining body (10), with the shell-type casing (20) and the connector insert (30), can be locked in place in the module mounting device (40), and in
that there is provided on the shell-type casing (20) a clip (28) by means of which a signal line, leading to the connector insert (30), can be fastened, the shielding braid of the signal line being contacted to the shell-type casing.

2. Plug-in connector module according to claim 1, characterized in that the shell-type casing (20) can be locked together with the retaining body (10).

3. Plug-in connector module according to claim 1 or 2, characterized in that the connector insert (30) can be fastened in the shell-type casing (20).

4. Plug-in connector module according to one of the preceding claims, characterized in that the clip (28) can be fastened to an elongated side surface (22) of the shell-type casing (20).
